(19) United States
(12) Patent Application Publication
(10) Pub. No.: US 2002/0073076 A1
(43) Pub. Date: Jun. 13, 2002

(54) System and method for enabling off-line database functionality

(76) Inventors: Yongjie Xu, Richmond, VA (US); Elden Liu, Tampa, FL (US)

Correspondence Address: MINTZ LEVIN COHN FERRIS GLOVSKY AND POPEO PC, ONE FOUNTAIN SQUARE, 11911 FREEDOM DRIVE, SUITE 400, RESTON, VA, 20190, US

(21) Appl. No.: 09/732,733

(22) Filed: Dec. 11, 2000

(51) Int. Cl. G06F 7/00

(52) U.S. Cl. 707/3

(57) ABSTRACT

A system and method for enabling off-line database functionality. The method includes creating at least one database file offline, modifying data in the created database file and uploading the created database file to a storage area over a network. The method also includes creating a database search template for the created database file and associating the database search template with a database search engine program. When the database search template is loaded on a client browser, the database search engine program starts execution within the client browser.

### FIELD OF THE INVENTION

This invention relates generally to database management, and more particularly to offline database management in a network-based system.

### BACKGROUND OF THE INVENTION

Internet web pages have gone from simple photo album and static content presentations to interactive searchable catalogs and advanced online order placing and tracking. Therefore, to support these functions, putting databases on the Internet is an integral part of current web site design and development. Processing of the information stored in such Internet databases, and the efficiency with which such processing is accomplished, have become increasingly important.

Database vendors have therefore introduced databases designed with web-ready features and various methods to access the information stored in such databases have been provided, such as Common Gateway Interface (“CGI”) invocation, Java/Java Database Connectivity (“JDBC”), Active-X™ and Cold Fusion™.

However, there are a number of deficiencies in such web-ready databases and the methods currently used for accessing and processing of the information stored in such databases. Stand-alone web servers tend to be stateless, i.e., do not save and carry over individual web page information from one web page to another. To provide an online user with a content-sensitive web page, database integration occurs at the web server side. When the online user issues a database query from the online user's web browser, the query is transmitted over the Internet through a web server, to a web server/database access interface, to a database server having the database stored therein. When the results of the query are returned with the information retrieved from the database, the query results are formatted and are then transmitted to the user's web browser.

Thus, the database resides on the web server side of the interaction, and database queries are executed remotely to the user who issues the query. Making database queries from a web server may be expensive and time consuming. Database vendors may charge license fees based on database connection times. And, when database queries are made from a web server, the database response time becomes dependent upon the web server response time.

Additionally, many business entities that are just entering Internet commerce and at the early stages of building a web site may not have the time and financial resources to equip a web site with a web server and a database server and may not desire to engage in the continuous administration required to maintain as current the information stored in databases supporting the web site.

These and other deficiencies exist in current web-based database systems.

### SUMMARY OF THE INVENTION

Thus, there is a need for a system and method that will enable a web site owner to build a web site with pages having database functionality for users of the web site without the requisite database server and database administration resources.

There is also a need for a system and method which enables processing of the information contained in a web-based database to be performed locally at the computer of an online user rather than at the web server side, thus enabling a web site owner to realize cost savings and the online user to realize a more efficient processing cycle and quicker response times.

Thus, in accordance with an embodiment of the present invention, there is provided a method for managing a database comprising the steps of (a) transmitting a database query from a client computer over a network through a server to a plurality of database file(s); (b) receiving data transmitted from the database file(s) through the server over the network; and (c) processing the database query on the received database file(s) at the client computer.

In another aspect of the invention, there is provided a system for managing a database comprising (a) means for transmitting a database query from a client computer over a network to a plurality of database file(s); (b) means for receiving data transmitted from the database file(s) through the server over the network; and (c) means for processing the database query on the received database file(s)at the client computer.

According to another aspect of the invention, when an online user first queries a database, the database file(s) is/are downloaded to a storage device associated with the user's client computer. Also downloaded to the storage device on the client computer is a database search engine program. The database search engine program and the downloaded database file(s) enable the user to perform the queries on the database file(s) stored locally at the client computer. Preferably, when the database file(s) is/are downloaded to the client computer, it is encrypted so that it is not usable without the database search engine program downloaded to the client computer. This preserves the integrity of the data in the database file(s) and prevents any unauthorized or unintended use of the data.

In another aspect of the invention, once the online user has downloaded a copy of a plurality of source database file(s) and the database search engine program, the downloaded database file(s) and the downloaded database search engine program are both stamped with an identifier (for example, a version number). When the online user executes a query of those downloaded database file(s), and the user is connected to a web server through which the source database file(s) and the source database search engine program can be accessed, the database search engine program causes a communication link to be established from the client computer to the web server to compare the version of the downloaded database file(s) stored locally on the user's client computer with the source database file(s) accessed via the web server. If there is a match, an indication of such is sent to the client computer and all database processing can be continued at the client computer. If the source version of the database file(s) differs from that stored locally at the client computer, the source database file(s) or portions thereof that differ from the downloaded database file(s) are downloaded to the client computer and the user's query is executed on the updated downloaded database file(s) stored on the client computer. Additionally, the version of the downloaded database search engine program stored locally is compared to the source database search engine program. If the two versions of the database search engine program do not match, then the source database search engine program may be downloaded.

One advantage of the present invention is that even if a user is connected to a database through a network connection, virtually all of the database processing occurs at the user's client computer thereby minimizing or significantly reducing the system load at the web server side. Additionally, the invention enables a user to update a database file by inputting the update at a local client computer and then uploading the updated file to the web server.

These and other features and advantages of the invention will be apparent through the detailed description of the preferred embodiments and the drawings attached hereto. It should be understood that both the foregoing general description and the following detailed description are exemplary and explanatory and not restrictive of the scope of the invention.

### BRIEF DESCRIPTION OF THE DRAWINGS

The invention will be described with respect to the accompanying drawings, in which like elements are referenced with like numbers.

FIG. 1 is a block diagram illustrating one embodiment of a system for enabling offline database functionality in accordance with the present invention;

FIG. 2 is a flow diagram illustrating the steps performed in one embodiment of a method for enabling offline database functionality in accordance with the invention;

FIG. 3 is a flow diagram illustrating the steps performed in one embodiment of a method for enabling offline database functionality; and

FIG. 4 is a flow diagram illustrating the steps performed in one embodiment of a method for enabling offline database functionality.

### DETAILED DESCRIPTION OF THE PREFERRED EMBODIMENTS

In an aspect of the invention, a system may be used for managing a plurality of database files using a computer, a processor, a network and other resources. According to one embodiment of the invention, the management of the database files is performed in response to the computer processor executing one or more sequences of one or more instructions contained in a main memory of the computer.

Such instructions may be read into the main memory from a computer-readable medium, such as a storage device. Execution of the sequences of instructions contained in the main memory causes the computer processor to perform the steps of the method described herein. It should be readily apparent, however, that one or more computer processors in a multi-processing arrangement may also be employed to execute the sequences of instructions contained in the main memory to perform such steps. In alternative embodiments, hard-wired circuitry may be used in place of, or in combination with, software-based instructions to implement the method of the invention. Thus, embodiments of the invention are not limited to any specific combination of hardware circuitry or software.

The term “computer-readable medium” as used herein refers to any medium that participates in providing instructions to the computer processor for execution. Such a medium may take many forms including, but not limited to, a non-volatile medium, a volatile medium, or a transmission medium. The transmission medium may include one or more coaxial cables, one or more copper wires or one or more fiber optic cables, including the wires that comprise a bus. The transmission medium can also take the form of one or more acoustic or light waves, such as those generated during radio frequency (RF) and infrared (IR) data communications. Common forms of computer-readable media include, for example, a floppy disk, a flexible disk, a hard disk, a magnetic tape, a compact disk-read only memory (CD-ROM), a digital video disk (DVD), one or more punch cards, a paper tape, a random access memory (RAM), a programmable read-only memory (PROM), an erasable programmable read only memory (EPROM), a FLASH-EPROM, any other memory chip or cartridge, a carrier wave, or any other medium from which a computer processor can read instructions for execution.

The system may also include a communication interface coupled to a bus. The communication interface may enable two-way data communication by coupling the computer to a network link that is connected to a local area network (LAN) or another network, such as the Internet. For example, the communication interface may be an integrated service digital network (ISDN) card or a modem to provide a data communication connection to a corresponding type of telephone line. As another example, the communication interface may be a LAN card to provide a data communication connection to a compatible LAN. Wireless links also may be implemented. In any such implementation, the communication interface sends and receives electrical, electromagnetic or optical signals that carry digital data streams representing various types of information.

The network link typically provides data communication through one or more networks to other data devices. For example, the network link may provide a connection through a LAN to a host computer, server or to other data equipment operated by an Internet Service Provider (ISP) or another entity. The ISP may, in turn, provide data communication services through the world wide packet data communication network, now commonly referred to as the “Internet”. The LAN and the Internet both use electrical, electromagnetic or optical signals that carry digital data streams. The signals through the various networks and the signals through the communication interface, which carry the digital data to and from the computer system, are exemplary forms of carrier waves transporting the information.

The system of the invention can send messages and receive data, including program code, through the network(s), the network link, and the communication interface. In the Internet example, a server might transmit a requested code for an application program to be downloaded through the Internet, the LAN and the communication interface. In accordance with the invention, one such downloaded application program provides for operating and maintaining the database and system described herein. The received code may be executed by the computer processor as it is received and/or may be stored in a storage device for later execution. In this manner, the system may obtain application program code via a carrier wave or other communications.

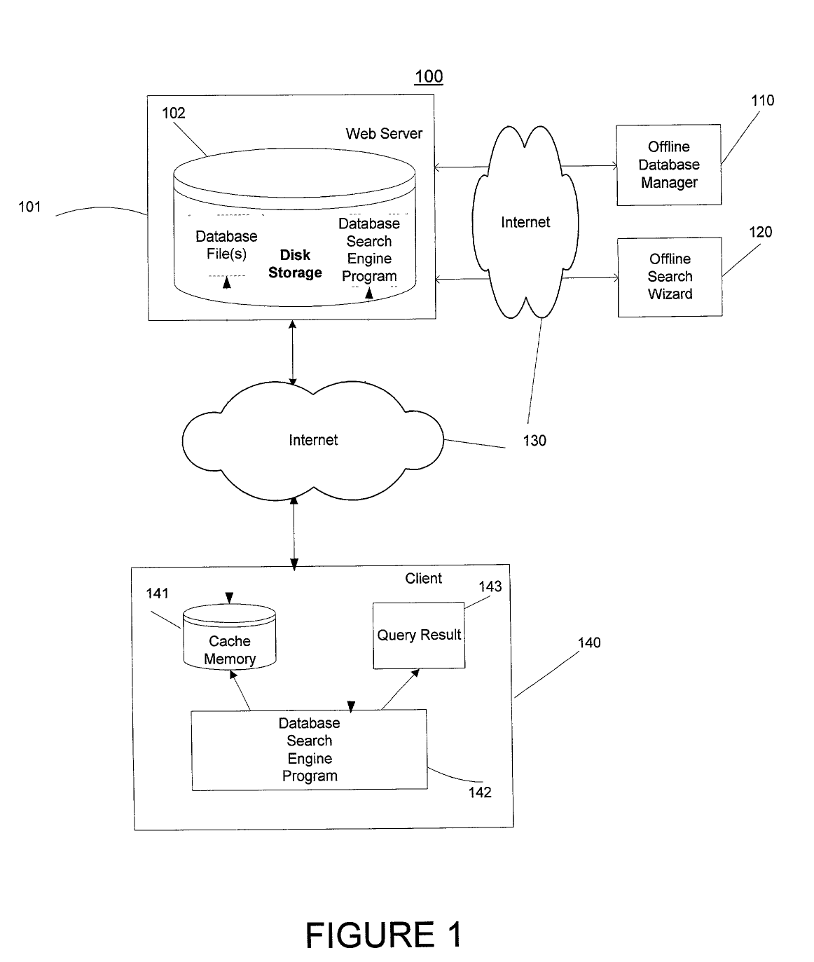

FIG. 1 is a block diagram illustrating one embodiment of a system 100 for enabling offline database functionality in accordance with the invention. The system 100 includes a web server 101, including a disk storage device 102, an offline database manager program 110, an offline search wizard 120, an Internet network link 130, a client computer 140 including a cache memory 141, a database search engine program 142 and a query results presenter module 143.

The web server 101 may be comprised of a workstation running a Microsoft Windows™ NT™ operating system, a Windows™ 2000 operating system, a Unix operating system, a Linux operating system, a Xenix operating system, an IBM AIX™ operating system, a Hewlett-Packard UX™ operating system, a Novell Netware™ operating system, a Sun Microsystems Solaris operating system, an OS/2™ operating system, a BeOS™ operating system, a MacIntosh operating system, an Apache operating system, an OpenStep™ operating system or another similar operating system or platform.

The web server 101 may be any type of web server including the disk storage device 102 for storing a plurality of database files. The database files stored in the disk storage device 102 may be accessed without using a database server. The database files may be searched at a location remote from the web server 101 to reduce resource and time demands on the web server 101. The web server 101 may be coupled to the offline database manager program 110, the offline search wizard 120 and the Internet network link 130 through one or more communications links. The database files stored in the disk storage device 102 may be created offline by using the offline database manager program 110.

The communications links may be comprised of, or may interface to any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection or a Copper Distributed Data Interface (CDDI) connection. The communications links may also include or interface to any one or more of a Wireless Application Protocol (WAP) link, a General Packet Radio Service (GPRS) link, a Global System for Mobile Communication (GSM) link, a Code Division Multiple Access (CDMA) link, a Time Division Multiple Access (TDMA) link such as a cellular phone channel, a Global Positioning System (GPS) link, a cellular digital packet data (CDPD) link, a Research in Motion (RIM) limited duplex paging type device, a Bluetooth radio link, or an IEEE 802.11-based radio frequency link. The communications links may also include or interface to any one or more of an RS-232 serial connection, an IEEE-1394 Firewire connection, a Fibre Channel connection, an infrared (IrDA) port, a Small Computer Systems Interface (SCSI) connection, a Universal Serial Bus (USB) connection or another wired or wireless, digital or analog interface or connection.

The offline database manager program 110 may create one or more new database file(s) and may be used to define a database record format for records to be stored in a database file. The offline database manager program 110 may also insert, delete or modify records within a database file. The offline database manager program 110 may create a new database file by importing a database table from an external data source, by modifying an existing database file or by manually creating a new database file through user input.

The external data source may include one or more existing databases. The existing databases may be formatted via use of an Oracles relational database application, such as that sold commercially by Oracle Corporation. Other commercial database applications, such as a database application sold by Informix™, a Database 2 (DB2) database application, a Sybase™ database application, an On Line Analytical Processing (OLAP) application, a Standard Query Language (SQL) application, a storage area network (SAN) application, a Microsoft Access™ application or other similar data storage or query formats, platforms or resources may also be used.

The offline database manager program 110 may further export records of an existing database file to the external data source. The offline database manager program 110 may upload database files to a remote storage area such as, for example, the disk storage device 102 of the web server 101.

To make remote stored database files available to online users (i.e., visitors to a web site), a web site owner may use the offline search wizard 120 to create and customize search pages and results pages. The offline search wizard 120 may allow an online user to select fields for a plurality of search criteria for a given database file, to define default search criteria (e.g., comparison operands, search field default values, etc.) and to generate a database search page with the selected search criteria. The offline search wizard 120 may also allow the online user to select which fields will be displayed in a results page for a given database file, and may be used to produce customized search results style sheets for generating a customized output and a database search results template page.

The client computer 140 may be comprised of a personal computer running a Microsoft Windows™ 95 operating system, a Windows™ 98 operating system, a Millenium™ operating system, a Windows™ NT™ operating system, Windows™ 2000 operating system, a Windows™CET™ operating system, a PalmOS™ operating system, a Unix™ operating system, a Linux™ operating system, a Solaris™ operating system, an OS/2™ operating system, a BeOS™ operating system, a MacOS™ operating system or another similar operating system or platform. The client computer 140 may include a microprocessor such as an Intel™ x86-based device, a Motorola™ 68K device, a PowerPC™ device, a MIPS device, a Hewlett-Packard Precision™ device, a Digital Equipment Corporation Alpha™ RISC processor, a microcontroller or another general or special purpose device operating under programmed control. The client computer 140 may further include an electronic memory such as a random access memory (RAM) or an erasable programmable read only memory (EPROM), a storage device such as a hard drive, a CD-ROM, a rewritable CD-ROM or another magnetic, optical or storage media, and other associated components connected over an electronic bus, as will be appreciated by persons skilled in the art. The client computer 140 may also include a network-enabled appliance such as a WebTV™ unit, a radio-enabled Palm™ Pilot or similar unit, a set-top box, a networkable game-playing console such as a Sony Playstation or a Sega Dreamcast™, a browser-equipped cellular telephone, or another TCP/IP client or other device.

The client computer 140 may be connected to the Internet network link 130 and, thus, to the web server 101. A browser application executed by the client computer 140 may communicate with the web server 101 through the Internet network link 130 or through another network using network-enabled code. The network-enabled code may be comprised of a Hyper Text Markup Language (HTML), a Dynamic HTML, an Extensible Markup Language (XML), an Extensible Stylesheet Language (XSL), a Document Style Semantics and Specification Language (DSSSL), a Cascading Style Sheets (CSS) language, a Synchronized Multimedia Integration Language (SMIL), a Wireless Markup Language (WML), a Java™ language, a Jini™ language, a C language, a C++ language, a Perl language, a UNIX™ Shell language, a Visual Basic or Visual Basic Script language, a Virtual Reality Markup Language (VRML), a ColdFusion™ language or another similar compiler, assembler, interpreter or other computer language or platform.

The client computer 140 may include the cache memory 141 for receiving the database files from the disk storage device 102. The client computer 140 may also include the database search engine program 142 to perform database search functions and the query results presenter module 143 to present the results of the query performed by the database search engine program 142.

The database search engine program 142 may be written as a client-side Java™ applet for execution. Each database search page generated by the offline search wizard 120 may reference the database search engine program 142. Based on inputs such as, for example, a database file name, one or more preset search criteria and/or the search results template, a database search query may be invoked locally by the web browser of the client computer 140 and the search results presenter module 143 may produce one or more results of the search query. If the results of the search query which are produced by the search results presenter module 143 are voluminous, the search results may be presented in multiple pages with navigation controls.

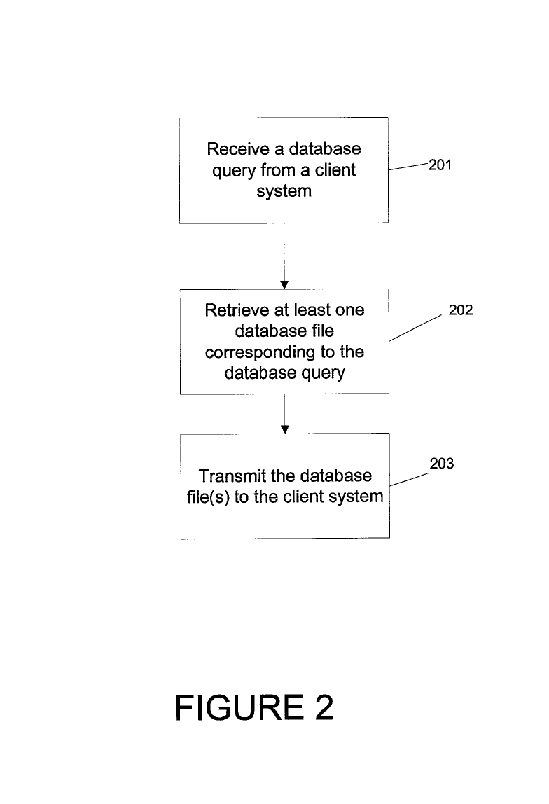

FIG. 2 is a flow diagram illustrating the steps performed in one embodiment of a method for enabling offline database functionality in accordance with the invention. As shown in FIG. 2, at step 201, the web server 101 may receive a database query from the client computer 140 which was transmitted over the Internet network link 130 from the client computer 140. The database query received by the web server 101 may be in a predetermined format, such as, for example, a search template formatted by the offline search wizard 120. At step 202, the web server 101 may retrieve at least one database file from the disk storage device 102 corresponding to the data responsive to the database query. The web server 101 may retrieve the responsive database file(s) from the disk storage device 102 using predetermined search criteria such as, for example, a database file name. At step 203, the web server 101 may transmit the retrieved database file(s) to the client computer 140 over the Internet network link 130.

The web server 101 may also download the database search engine program 142 along with the database file to be stored in the cache memory 141 of the client computer 140. The database search engine program 142 and the database file(s) downloaded may enable the user to execute the database queries and perform the associated processing of such queries at the client computer 140. Downloading the database file(s) to be queried is particularly advantageous when the storage capacity of the web server 101 is relatively small so that the load on the web server 101 may be minimized. When the database file is downloaded, it may be encrypted so that it is not usable without the downloaded database search engine program 142 on the client computer 140, thereby preserving the integrity of the data and preventing any unauthorized or unintended use of the data.

Each of the downloaded database file(s) may be stamped with an identifier such as, for example, a version number. The downloaded database search engine program 142 may also be stamped with an identifier such as a version number. When the user executes a query of the received downloaded database file(s) stored in the cache memory 141, the client computer 140 may be connected to the Internet network link 130 through which the source database file(s) stored in the disk storage device 102 may be accessed. The database search engine program 142 downloaded along with the database file(s) may send an instruction to the client computer 140 to cause a communication link to be established from the client computer 140 to the web server 101 in order to compare the versions of the database search engine program 142 with the downloaded versions of the database search engine program 142 and the database file(s) stored in the cache memory 141 with the database files stored in the disk storage device 102 of the web server 101.

If the downloaded version of the database search engine program 142 matches the database search engine program 142 at the web server 101, and the database file(s) stored locally in the cache memory 141 match the database files stored in the disk storage device 102, an indication of a match may be sent to the client computer 140 so that processing of the database queries may be continued at the client computer 140. If the downloaded version of the database search engine program 142 or the version of the database files stored in the disk storage device 102 differs from the database file(s) stored locally in the cache memory 141, the database search engine program 142, the database files, or portions thereof, stored in the disk storage device 102 may be downloaded to the client computer 140 so that the user's database query may be executed using the latest versions of the database search engine program 142, or the database files on the client computer 140. Thus, even if the user is connected to the Internet network link 130, virtually all of the database processing occurs locally at the client computer 140, thereby minimizing or significantly reducing the load at the web server 101 side.

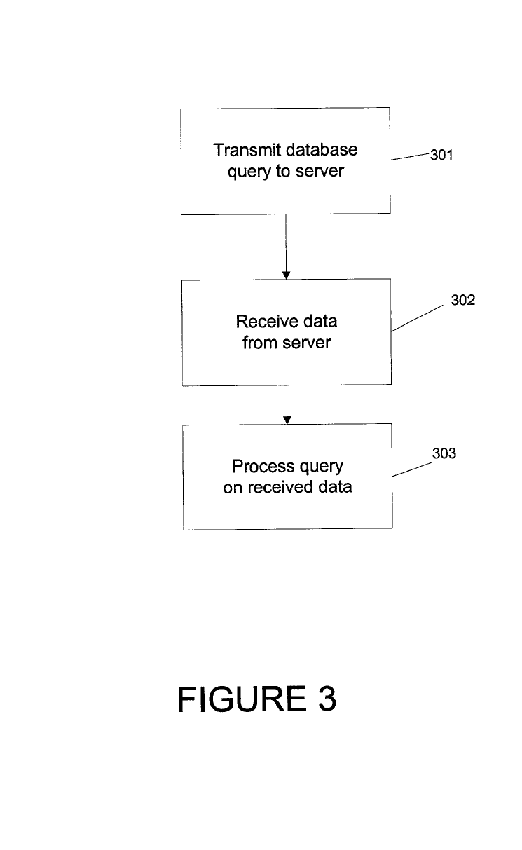

FIG. 3 is a flow diagram illustrating the steps performed in one embodiment of a method for enabling offline database functionality. As shown in FIG. 3, at step 301, the user may transmit a database query from the client computer 140 over the Internet network link 130 through the web server 101 to the database file(s) stored in the disk storage device 102. Step 301 may also include loading a database search page over the Internet network link 130, receiving the search page and loading the database search engine program 142 into the cache memory 141 of the client computer 140. In step 301, the user may also be required to transmit user authentication information to the web server 101 as an additional security measure to limit access to the database files to an authorized user. The user at the client computer 140 may define one or more search criteria and a search results layout when the user defines the database search and transmits the database query to the web server 101. The search criteria or parameters may include a database file name, a search condition, a results layout, a results page index and a number of records to be presented on one page.

At step 302, the client computer 140 may receive data from the database files stored in the disk storage device 102 of the web server 101. The data may be received in the form of at least one database file. The database file(s) may include a database file identifier, such as, for example, a database file version. The received database file(s) may be stored in the cache memory 141. The client computer 140 may also receive, with the database file(s), a plurality of search parameters from the web server 101 that the user previously transmitted to the web server I 101 as a part of the database query transmitted to the web server 101. The database files received from the web server 101 may be encrypted so that the data in the database file(s) may not be accessed without the database search engine program 142 received from the web server 101. At step 303, the client computer 140 may process the database query on the received data using the database search engine program 142 and the search parameters received from the web server 101.

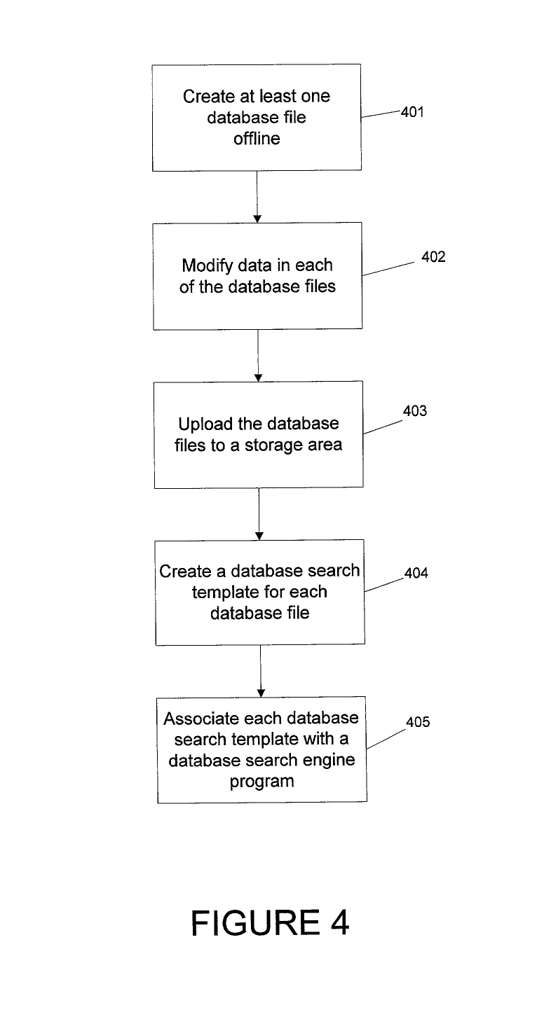

FIG. 4 is a flow diagram illustrating the steps performed in a method for enabling offline database functionality in accordance with the invention. As shown in FIG. 4, at step 401, at least one database file may be created offline. Each database file may correspond to one or more database table(s). The system 100 may use a proprietary binary-format database file to represent each database table. Each database file created may include a table having a table header, at least one field header, and at least one data record. The database file created may also define one or more data types supported by the database file. The table header may include a database identifier, a total number of fields in the table, a total number of records in the table, a total record length, a field header identifier associated with each field header, and a record identifier associated with each data record. The field header may include a field name, a field data type and a field length. The supported data types may include character data such as a regular character string, metadata including an image, a text, a URL tag, or numeric data including an integer or a floating point number. The database file created may further include at least one record. The database file may be created manually by a database administrator or automatically by importing an external database table directly from an external data source such as, for example, an open database connectivity (“ODBC”) data source.

The offline database manager program 110 may be used for creating the database file. The offline database manager program 110 may be a Windows™-based application which allows the user to create or modify database files offline. The offline database program 110 may open multiple database files at the same time and may provide either a structure view or a data view for a loaded database file. The offline database manager program 110 may also allow the user to upload a current database file to the user's online account residing, for example, on the web server 101, using a file transfer protocol (“FTP”) or similar network protocols. A plurality of menu options for functions which can be performed using the offline database manager program 110 may include, under a FILE drop-down menu, an option to create a new file, an option to open a preexisting file and an option to close a file. Under a VIEW drop-down menu, the user may view a file employing either a structure view or a data view. Under a TOOLS drop-down menu, the user may import data from one file into another or may export data from one file or may upload data by using FTP.

At step 402 in FIG. 4, the created or existing database files may be modified. Step 402 may further include adding a record to the created or existing database file, deleting a record from the created or existing database file or updating a record in the created or existing database file. At step 403, the modified database files may be uploaded to a storage area such as, for example, the disk storage device 102 of the web server 101.

At step 404, a database search template may be created for each uploaded database file.

The database search template may be created using the offline search wizard 120. The offline search wizard 120 may be another Windows™ based application that allows the user to create various search pages configured to a specific database file. Each search page created may include a specific search criteria. For example, if a “wild card” search on a product name field, or a “greater than” search on a price field is desired, these search conditions and parameters may be included in the final created search template. The step 404 of creating the search template may further include selecting a database file, defining a plurality of search criteria, and choosing a plurality of fields to be included in the search criteria. Step 404 may also include the sub-step of creating a result template for displaying the results of a search in the search results presenter module 143 of the client computer 140. The sub-step of creating the result template may include choosing fields to be included in a result display. The step 404 of creating the search template may further include the sub-step of using a default style page if the user does not choose to select a style page or creating a search page using a user-selected style page if the user chooses to select a style page. Thus, the user may generate a style page which is consistent with the user's other web pages, in order to maintain a web site style consistency.

At step 405, each database search template created may be associated with the database search engine program 142. Creating an association with the database search engine program 142 for each database search template allows the database search engine program 142 to start execution within the browser application when executed by the client computer 140 when the database search template is loaded on the browser.

After the search pages are generated and uploaded online to the disk storage device 102, the user may point his/her web browser to the search pages and may perform various database queries against the associated database files.

The database search engine program 142 may be built as a Java™ applet. The database search engine program 142 may be referenced by each search page generated by the offline search wizard 120. When a search page is loaded into the user's web browser, the Java™ applet may start its execution locally. Alternatively, the database search engine program 142 may be designed and implemented as a black box driven totally by external parameters. The external parameters may include a database file name, one or more search conditions, and one or more result display options, etc. The external parameters may be defined and generated by the offline search wizard 120.

When the database search engine program 142 completes execution of a database query, and builds its search results, if there are metadata field returns, the metadata field returns may be processed according to one or more predetermined rules. For example, if the search results include an image (“IMG”) tag, an associated relative path to an image file may be resolved and an image may be displayed in the search results presenter module 143. If the search results include a URL tag, the URL may be available if the user clicks on the displayed field. If the search results include a text (“TXT”) tag, a text description may be shown in a pop-up tool-tip box.

As has been explained above, in the system 100 of the present invention, by offloading database processing to the client computer 140, the web server's 101 processing resources may be utilized more efficiently. Also, by offloading database processing to the client computer 140, server-side database connection license fees will be reduced, thereby lowering costs associated with web site administration.

When used with the system 100 for enabling offline database functionality, the web server 101 does not need to be equipped with a database server online for small databases, such as an online address book, but web site users may still experience the same database functionality. Web site users may build web pages with database functionality, even though the hosting web server 101 may not have database support. Because the system 100 does not require complex support of web server-side scripting, such as, for example, common gateway interface (“CGI”), etc., on the web server 101, the system 100 for enabling offline database functionality may be deployed on any kind of web server 101.

Other embodiments, uses and advantages of the invention will be apparent to those skilled in the art from consideration of the specification and practice of the invention disclosed herein. The specification should be considered exemplary only, and the scope of the invention is accordingly intended to be limited only to the following claims.

What is claimed is:

1. A method for managing a database comprising the steps of:
(a) transmitting a database query from a client computer over a network through a server to a plurality of database file(s);
(b) receiving data transmitted from the database file(s) through the server over the network; and
(c) processing the database query on the received database file(s) at the client computer.

2. The method of claim 1 further comprising the step of transmitting user authentication information to the server.

3. The method of claim 1 further comprising the step of storing the received data in a cache memory.

4. The method of claim 1 wherein the step of processing the database query includes the sub-step of a search engine program receiving a plurality of user-supplied search parameters included in the database query.

5. The method of claim 1 further comprising the step of receiving a database search engine program for processing the database query on the received data.

6. The method of claim 5 wherein the step of processing the database query includes the sub-step of running the database search engine program.

7. The method of claim 6 wherein the database search engine program is embedded in an Internet web page.

8. The method of claim 5 wherein the step of receiving the data comprises receiving encrypted data which cannot be accessed without the database search engine program.

9. The method of claim 1 wherein the received data comprises a plurality of database files(s).

10. The method of claim 9 further comprising the step of defining at least one search criteria and a search result layout associated with the database files(s).

11. The method of claim 10 wherein the step of defining at least one search criteria and the search result layout is performed on a database search page.

12. The method of claim 1 wherein the received data comprises an identifier and the step of processing the database query comprises the sub-steps of:
(a) establishing a communications link to the server over the network;
(b) comparing the received identifier to a corresponding identifier at the server;
(c) receiving an indication of a match if the received identifier matches the corresponding identifier at the server;
(d) and receiving updated data from the server if the received identifier does not match the corresponding identifier at the server.

13. The method of claim 12 wherein the sub-step of receiving the updated data comprises the sub-sub-step of receiving an updated database file.

14. The method of claim 1 wherein the network is the Internet.

15. The method of claim 1 wherein the step of processing the database query on the received data includes the sub-steps of:
(a) retrieving one or more predefined search parameters;
(b) reading the received data;
(c) retrieving a table definition for the received data;
(d) retrieving one or more data records that match the one or more predefined search parameters; and
(e) displaying the one or more data records in a format according to the one or more predefined search parameters.

16. The method of claim 15 wherein the one or more predefined search parameters comprise at least one of a database file name, a search condition, a result layout, a result page index, and a number of data records in one result page.

17. A system for managing a database comprising:
(a) means for transmitting a database query from a client computer over a network through a server to a plurality of database file(s);
(b) means for receiving data transmitted from the database file(s) through the server over the network; and
(c) means for processing the database query on the received database file(s)at the client computer.

18. The system of claim 17 further comprising means for transmitting user authentication information to the server.

19. The system of claim 17 further comprising means for storing the received data in a cache memory.

20. The system of claim 17 wherein the means for processing the database query includes search engine means for receiving one or more user-supplied search parameters from the database query.

21. The system of claim 20 wherein the means for processing the database query comprises means for running the search engine means.

22. The system of claim 21 wherein the search engine means is embedded in an Internet web page.

23. The system of claim 20 wherein the means for receiving the data comprises receiving encrypted data wherein the encrypted data cannot be accessed without using the search engine means.

24. The system of claim 17 wherein the received data comprises a database file(s).

25. The system of claim 24 further comprising means for defining at least one of search criteria and a search result layout associated with the database file(s).

26. The system of claim 25 wherein the means for defining at least one of the search criteria and the search result layout is performed on a database search page.

27. The system of claim 17 wherein the received data comprises an identifier and the means for processing the database query includes:
(a) means for establishing a communications link to the server over the network;
(b) means for comparing the received identifier to a corresponding identifier at the server;
(c) means for receiving an indication of a match if the received identifier matches the corresponding identifier at the server; and
(d) means for receiving updated data from the server if the received identifier does not match the corresponding identifier at the server.

28. The system of claim 27 wherein the means for receiving the updated data includes means for receiving an updated database file.

29. The system of claim 17 wherein the network is the Internet.

30. The system of claim 17 wherein the means for processing the database query on the received data comprises:
(a) means for retrieving one or more predefined search parameters;
(b) means for reading the received data;
(c) means for retrieving a table definition for the received data;
(d) means for retrieving one or more data records that match the one or more predefined search parameters; and
(e) means for displaying the one or more data records in a format according to the one or more predefined search parameters.

31. The system of claim 30 wherein the one or more predefined search parameters comprise at least one of a database file name, a search condition, a result layout, a result page index, and a number of data records in one result page.

32. A method for managing a database comprising the steps of:
(a) transmitting a database search page template from a server a network;
(b) receiving the database search page template in a client computer;
(c) receiving one or more search criteria in the transmitted database search page template;
(d) executing a database query in the client computer using a database search engine program and the database search page template;
(e) receiving a remotely residing database file transmitted from the server over the network to the client computer; and
(f) presenting a search result in the client computer.

33. A system for managing a database comprising:
(a) means for transmitting a database search page template from a server over a network;
(b) means for receiving the database search page template in a client computer;
(c) means for receiving one or more search criteria in the transmitted database search page template;
(d) means for executing a database query in the client computer using a database search engine program and the database search page template;
(e) means for receiving a remotely residing database file transmitted from the server over the network to the client computer; and
(f) means for presenting a search result in the client computer.

34. A method of managing a database, comprising the steps of:
(a) creating at least one database file offline;
(b) modifying data in the at least one database file;
(c) uploading the at least one database file to a storage area over a network;
(d) creating a database search template for the at least one database file; and
(e) associating the created database search template with a database search engine program wherein the database search engine program starts execution within a client browser when the database search template is loaded on the client browser.

35. The method of claim 34 wherein the step of creating the database file includes the sub-step of importing an external database table into the database file.

36. The method of claim 34 wherein the step of creating the database file includes the sub-step of constructing a table including a table header, at least one field header corresponding to at least one field having at least one data record, and one or more supported data types.

37. The method of claim 36 wherein the table header comprises at least one of a database identifier, a total number of fields, a total number of data records, a total data record length, a field header identifier associated with each field header, and a data record identifier associated with each data record.

38. The method of claim 36 wherein the at least one field header comprises at least one of a field name, a field data type and a field length.

39. The method of claim 34 wherein the step of modifying the data includes at least one of the sub-steps of adding data to the database file, deleting data from the database file and modifying data in the database file.

40. The method of claim 34 wherein the step of creating the database search template includes the sub-steps of:
(a) selecting a database file;
(b) choosing one or more fields to be included in a search criteria;
(c) defining the search criteria;
(c) choosing fields to be included in a resulting display; and
(d) creating a search page using a default style page if a user does not choose to select a style page or creating a search page using a user-selected style page if the user chooses to select a style page.

41. A system of managing a database, comprising:
(a) means for creating at least one database file offline;
(b) means for modifying data in the at least one database file;
(c) means for uploading the at least one database file to a storage area over a network;
(d) means for creating a database search template for the at least one database file; and
(e) means for associating the created database search template with a database search engine program wherein the database search engine program starts execution within a client browser when the database search template is loaded on the client browser.

42. The system of claim 41 wherein the means for creating the database file includes means for importing an external database table into the database file.

43. The system of claim 41 wherein the means for creating the database file includes means for constructing a table including a table header, at least one field header corresponding to at least one field having at least one data record, and one or more supported data types.

44. The system of claim 43 wherein the table header includes at least one of a database identifier, a total number of fields, a total number of data records, a total data record length, a field header identifier associated with each field header, and a data record identifier associated with each data record.

45. The system of claim 43 wherein the at least one field header includes at least one of a field name, a field data type and a field length.

46. The system of claim 41 wherein the means for modifying the data includes at least one of means for adding data to the database file, means for deleting data from the database file and means for modifying data in the database file.

47. The system of claim 41 wherein the means for creating the database search template includes:
(a) means for selecting a database file;
(b) means for choosing one or more fields to be included in a search criteria;
(c) means for defining the search criteria;
(d) means for choosing fields to be included in a resulting display; and
(e) means for creating a search page using a default style page if a user does not choose to select a style page or means for creating a search page using a user-selected style page if the user chooses to select a style page.

48. A method of managing a database comprising the steps of:
(a) transmitting a database query in a predetermined format from a client computer over a network through a server to a plurality of database file(s);
(b) retrieving at least one database file corresponding to the database query from the database file(s); and
(c) transmitting the retrieved at least one database file to the client computer over the network.

49. The method of claim 48 further comprising the steps of:
(a) receiving an identifier associated with the at least one transmitted database file from the client computer at the server;
(b) comparing the received identifier with an identifier associated with the corresponding at least one database file stored in the database;
(c) transmitting an indication of a match if the received identifier matches the identifier associated with the corresponding at least one database file; and
(d) transmitting an updated database file to the client computer if the received identifier does not match the identifier associated with the corresponding at least one database file.

50. A system of managing a database comprising:
(a) means for transmitting a database query in a predetermined format from a client computer over a network through a server to a plurality of database file(s);
(b) means for retrieving at least one database file corresponding to the database query from the database file(s); and
(c) means for transmitting the retrieved at least one database file to the client computer over the network.

51. The system of claim 50 further comprising:
(a) means for receiving an identifier associated with the at least one transmitted database file from the client computer at the server;
(b) means for comparing the received identifier with an identifier associated with the corresponding at least one database file stored in the database;
(c) means for transmitting an indication of a match if the received identifier matches the identifier associated with the corresponding at least one database file; and
(d) means for transmitting an updated database file to the client computer if the received identifier does not match the identifier associated with the corresponding at least one database file.
